(19) United States
(12) Patent Application Publication
(10) Pub. No.: US 2026/0110950 A1
(43) Pub. Date: Apr. 23, 2026

(54) CAMERA MODULE

(71) Applicant: Samsung Electro-Mechanics Co., Ltd., Suwon-si (KR)

(72) Inventors: Yunjeong HWANG, Suwon-si (KR); Gye-Won LEE, Suwon-si (KR); Jongwoon KIM, Suwon-si (KR); Seung Hun RYU, Suwon-si (KR); Won SEO, Suwon-si (KR); Joonhyung LIM, Suwon-si (KR); Hwahyun JEON, Suwon-si (KR)

(73) Assignee: Samsung Electro-Mechanics Co., Ltd., Suwon-si (KR)

(21) Appl. No.: 19/290,827

(22) Filed: Aug. 5, 2025

(30) Foreign Application Priority Data
Oct. 22, 2024 (KR) 10-2024-0145066
Mar. 10, 2025 (KR) 10-2025-0030476

(51) Int. Cl. G03B 17/55; F21K 5/06; G03B 17/12; H04N 23/52; H04N 23/56

(52) U.S. Cl. CPC G03B 17/55; G03B 15/0442; G03B 17/12; H04N 23/52; H04N 23/56

(57) ABSTRACT

A camera module includes a lens module; a circuit board, disposed on the lens module, on which an image sensor is disposed; a light-emitting diode (LED) module disposed to be spaced apart from the circuit board; a post disposed between the circuit board and the LED module to support the LED module; and a first heat dissipation member disposed on the LED module.

### CROSS-REFERENCE TO RELATED APPLICATION

This application claims the benefit under 35 USC 119(a) of Korean Patent Application Nos. 10-2024-0145066 filed on Oct. 22, 2024, and 10-2025-0030476 filed on Mar. 10, 2025, the entire disclosures of which are incorporated herein by reference for all purposes.

### BACKGROUND

### 1. Field

The present disclosure relates to a camera module.

### 2. Description of the Background

Due to the remarkable development of information and communication technology, semiconductor technology, and the like, cameras may be used in moving mechanical devices such as an autonomous vehicle and an industrial robot.

A camera module installed in a vehicle may be used in various positions, such as the front, side, rear, and interior room mirror of the vehicle. While a camera in an industrial robot may be disposed at the front of a face, the side of the face, the rear of the face, a palm, the back of a hand, a wrist, or the front of a knee of the industrial robot.

Because the camera module for the vehicle and the camera for the industrial robot are used in a confined space or a harsh external environment, thermal dissipation inside the camera module may be an issue.

Camera modules used in vehicles and industrial robots may be high-performance cameras that include high-pixel image sensors and LEDs (light-emitting diodes). In IR LED (Infrared light-emitting diode) cameras assembled using a bonding method with the LED board tilted, the space desired to apply a heat dissipation structure may be an issue due to the bond application area.

Therefore, it may be desirable to develop a structure capable of minimizing an increase in the size of the module while efficiently dissipating heat inside the camera module.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a lens module; a circuit board, disposed on the lens module, on which an image sensor is disposed; a light-emitting diode (LED) module disposed to be spaced apart from the circuit board; a post disposed between the circuit board and the LED module to support the LED module; and a first heat dissipation member disposed on the LED module.

The LED module may include an LED chip and an LED substrate, and the first heat dissipation member may be disposed around the LED chip.

The camera module may further include an upper housing that accommodates the lens module and the LED module, and a lower housing that couples with the upper housing and supports the circuit board.

The first heat dissipation may be disposed between the upper housing and the LED substrate.

The upper housing may include a surface having a first opening extending through the surface to expose the lens module, and a second opening extending through the surface to expose the LED module.

The camera module may further include a gasket disposed in the first opening to connect the lens module with the upper housing.

The lower housing may include a chassis coupled to a lower portion of the circuit board, the chassis having a surface including an opening extending through the surface to expose a portion of the circuit board, and a shield cover coupled to a lower portion of the chassis.

The circuit board and the LED module may be electrically connected by the post.

The camera module may further include an image sensor, disposed below the lens module, on a surface of the circuit board.

The camera module may further include a second heat dissipation member disposed on the surface of the circuit board.

The camera module may further include at least one third heat dissipation member disposed on a rear surface of an electronic component mounted on the circuit board.

The electronic component may include a serializer/deserializer and a power management integrated circuit.

The lens module may include a lens barrel accommodating at least one lens, and a lens holder accommodating the lens barrel.

The lens holder may include an extension part that extends through a surface of the circuit board.

The camera module may further include a second heat dissipation member disposed below a lower surface of the extension part.

The first heat dissipation member may include either one or both of a thermal interface material and a phase change material.

The first heat dissipation member may include any one or any combination of any two or more of a heat dissipation pad, a heat dissipation film, a heat dissipation grease, a heat dissipation adhesive, and a heat dissipation tape.

Other features and aspects will be apparent from the following detailed description, the drawings, and the claims

### BRIEF DESCRIPTION OF DRAWINGS

FIG. 1 is a perspective view illustrating an appearance of a camera module according to an embodiment.

FIG. 2 is an exploded perspective view schematically illustrating the camera module according to an embodiment.

FIG. 3 is a perspective view illustrating a portion of the camera module according to an embodiment.

FIG. 4 is an exploded perspective view schematically illustrating a lens module of the camera module according to an embodiment.

FIG. 5 is an exploded perspective view schematically illustrating a heat dissipation structure of a LED module of the camera module according to an embodiment.

FIG. 6 is a perspective view illustrating an upper housing of the camera module according to an embodiment.

FIG. 7 is a perspective view illustrating a chassis of the camera module according to an embodiment.

FIG. 8 is a perspective view illustrating a shield cover of the camera module according to an embodiment.

FIG. 9 is a cross-sectional view taken along a line V-V′ of FIG. 1.

FIG. 10 is a view showing a heat dissipation path of the camera module according to an embodiment.

FIG. 11 is a cross-sectional view schematically illustrating a camera module according to another embodiment.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

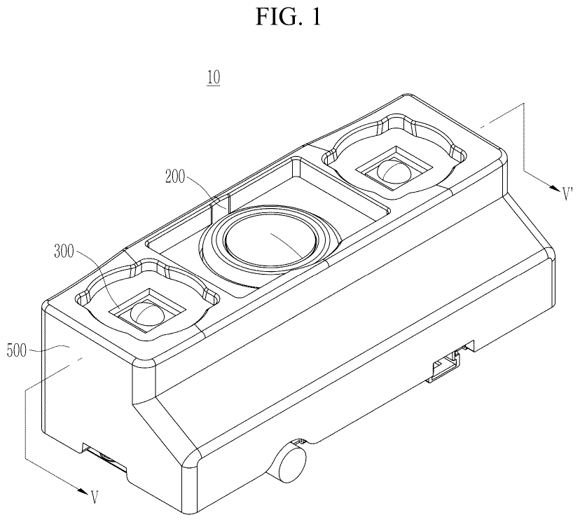

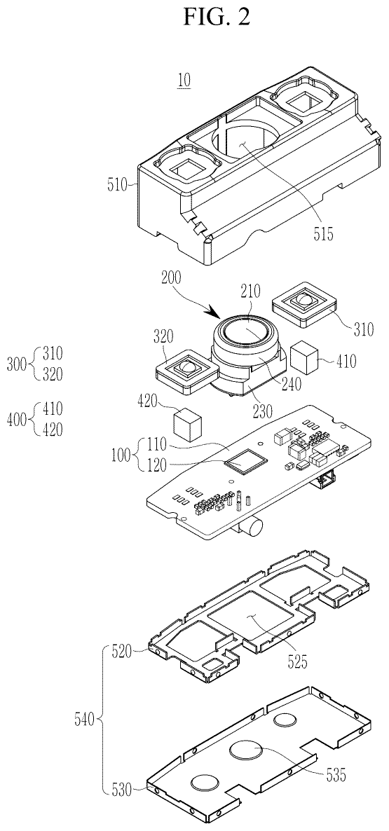

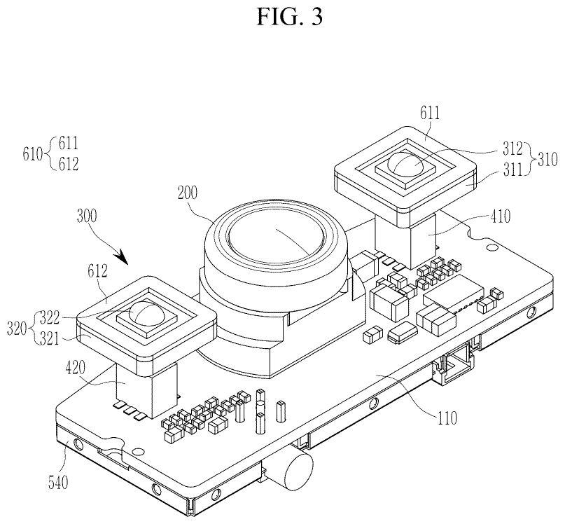

FIG. 1 is a perspective view illustrating the appearance of a camera module according to an embodiment. FIG. 2 is an exploded perspective view schematically illustrating the camera module according to an embodiment. FIG. 3 is a perspective view illustrating a portion of the camera module according to an embodiment.

Referring to FIGS. 1 to 3, a camera module 10 according to an embodiment may include an image sensor module 100, a lens module 200, a light emitting diode (LED) module 300, and a housing assembly 500.

The image sensor module 100 may include a circuit board 110 and an image sensor 120. The circuit board 110 may be electrically connected to a main board (not shown), and may include a circuit board with a wiring pattern capable of being electrically connected, such as a rigid circuit board, a flexible circuit board, or a rigid flexible circuit board.

The image sensor 120 may be a device that converts light incident through a lens of the lens module 200 into an electrical signal, and may be any one of a charge-coupled device (CCD) and a complementary metal oxide semiconductor (CMOS), but the present disclosure is not limited thereto.

The image sensor 120 may be mounted on one surface of the circuit board 110, and may be disposed below the lens module 200 along an optical axis direction of the lens. The image sensor 120 and the circuit board 110 may be connected by a method such as wire bonding. The electrical signal converted by the image sensor 120 may be output as an image through a display unit (or a display portion) of an electronic device.

The lens module 200 may include at least one lens 210 and a lens barrel 220 that accommodates the lens 210. The lens 210 may include one or more lenses having optical characteristics such as the same or different refractive indices, and may be installed at the lens barrel 220 along an optical axis. The optical axis may be set as a central axis of the lens accommodated in the lens barrel 220, and a direction of the optical axis may mean a direction parallel to the central axis. The number of lens 210 may vary as desired depending on the design of the lens barrel 220.

The lens barrel 220 may have a hollow cylindrical shape so that at least one lens 210 photographing a subject may be accommodated therein, the image sensor 120 may be disposed below the lens barrel 220 along the direction of the optical axis to convert light incident through the lens barrel 220 into an electrical signal, and the electrical signal may be transferred to the circuit board 110 and may be transmitted to an electronic device such as a mobile phone.

The LED module 300 may act as light at night, on cloudy days, or in dark places to brighten images. The LED module 300 may be disposed around the lens module 200, and may include a first LED module 310 and a second LED module 320, each disposed on the left and right sides.

The housing assembly 500 may protect an internal component of the camera module 10, may be formed of an aluminum or a metal plate, and may be formed of a material with a low corrosion rate, such as stainless steel (SUS). Additionally, the housing assembly 500 may function to shield an electromagnetic wave. For example, the housing assembly 500 may shield the electromagnetic wave to prevent an electromagnetic wave generated inside the camera module 10 from affecting another electronic component within an electronic device or to prevent a noise current flowing from outside the camera module 10 from affecting the inside of the camera module 10.

The housing assembly 500 may include an upper housing 510 that accommodates the lens module 200 and the LED module 300, and a lower housing 540 that is coupled to the upper housing 510 and supports the image sensor module 100. The upper housing 510 and the lower housing 540 may be coupled to each other to form an internal space of the camera module 10.

Electronic components such as a serializer/deserializer (SerDes) 150 for high-speed data transmission and a power management integrated circuit (PMIC) 170 for generating, distributing, and controlling electric power desired for each component within the camera module 10 may be disposed in an internal space formed by the housing assembly 500.

The upper housing 510 may have an opening 515 extending through a surface of the upper housing 510 to expose a portion of the lens module 200 and the LED module 300.

The lower housing 540 may include a chassis 520 coupled to a lower portion of the circuit board 110 of the image sensor module 100 and a shield cover 530 coupled to a lower portion of the chassis 520. Both the chassis 520 and the shield cover 530 may be manufactured by bending a plate-shaped member of stainless steel (SUS), and may be manufactured with a thickness of 0.15 to 0.3 mm so that the chassis 520 and the shield cover 530 may be miniaturize compared with a conventional aluminum cover and may be advantageous in dissipating heat.

The chassis 520 may be formed by bending an edge of the plate-shaped member to accommodate the circuit board 110, and the shield cover 530 may be formed by bending an edge of the plate-shaped member to accommodate the circuit board 110 and the chassis 520.

The chassis 520 may have at least one opening 525 extending through a surface of the chassis 520 to expose at least a portion of one surface of the circuit board 110, and the shield cover 530 may include at least one protruding portion 535 corresponding to the opening 525.

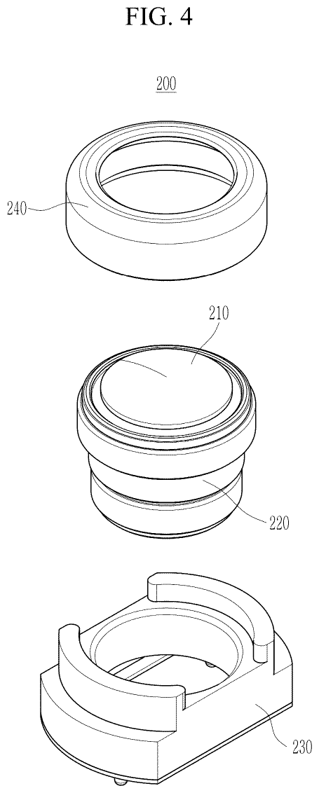

Hereinafter, the lens module 200 of the camera module 10 according to the present embodiment will be described in more detail with reference to FIG. 4. FIG. 4 is an exploded perspective view schematically illustrating a lens module of the camera module according to an embodiment.

Referring to FIG. 4, the lens module 200 may include at least one lens 210, a lens barrel 220 that accommodates the lens 210, and a lens holder 230 that accommodates the lens barrel 220.

The lens holder 230 may be a device for mounting the lens module 200 on the circuit board 110 and may include a lens actuator (not shown) that moves the lens module 200.

The lens actuator may include an AF driving unit (or an AF driving portion) and an OIS driving unit (or an OIS driving portion), and may move the lens barrel 220 to adjust focus or correct shaking. For example, the AF driving unit may include an AF driving magnet and an AF driving coil, and may implement a function of adjusting focus or a zoom function by moving the lens barrel 220 along the optical axis by electromagnetic influence between the AF driving magnet and the AF driving coil. In addition, the OIS driving unit may include an OIS driving magnet and an OIS driving coil, and may implement a function of correcting hand shaking or shaking by moving the lens barrel 220 in a direction perpendicular to the optical axis by electromagnetic influence between the OIS driving magnet and the OIS driving coil.

The lens holder 230 may accommodate a lens actuator and the lens barrel 220 in an internal space thereof, and may be disposed on the circuit board 110. The lens barrel 220 may move in the direction of the optical axis or the direction perpendicular to the optical axis in a state in which the lens barrel 220 is accommodated in the lens holder 230 by a driving force of the lens actuator.

The lens holder 230 may have an opening extending through a surface of the lens holder 230 accommodate the lens barrel 220 formed at an upper portion thereof, and may have an open lower portion so that the image sensor 120 is disposed at a lower portion thereof. Accordingly, the lens holder 230 may include an upper surface having an opening formed therein for accommodating the lens barrel 220 and a side surface extending downward from the upper surface.

The lens module 200 may further include a gasket 240 to fill the space formed between the lens module 200 and the upper housing 510. The gasket 240 may connect the lens module 200 and the upper housing 510, ensuring that all light incident on the camera module 10 enters the lens module 200. The gasket 240 may also function to shield electromagnetic waves.

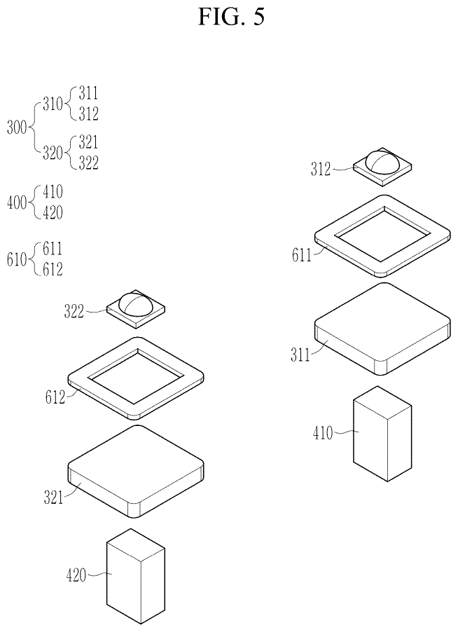

Hereinafter, a heat dissipation structure of the LED module of the camera module 10 according to the present embodiment will be described in more detail with reference to FIG. 5. FIG. 5 is an exploded perspective view schematically illustrating a heat dissipation structure of an LED module of the camera module according to an embodiment.

Referring to FIG. 5, the LED module 300 may be disposed apart from the circuit board 110 and may include the first LED module 310 and the second LED module 320. The first LED module 310 may include a first LED substrate 311 and a first LED chip 312, and the second LED module 320 may include a second LED substrate 321 and a second LED chip 322.

A post 400 may be disposed between the circuit board 110 and the LED module 300 and support the LED module 300. Therefore, the LED module 300 may be disposed to be spaced apart from the circuit board 110 through the post 400.

The post 400 may include a first post 410 configured to position the first LED module 310 apart from the circuit board 110 and a second post 420 configured to position the second LED module 320 apart from the circuit board 110.

The first post 410 and the second post 420 may support the first LED substrate 311 and the second LED substrate 321. The first post 410 and the second post 420 may respectively include electrode terminals, which electrically connect the first LED module 310 and the second LED module 320 to the circuit board 110.

A first heat dissipation member 610 may be disposed on the LED module 300. The first heat dissipation member 610 may form a heat transfer path that dissipates the heat generated from the LED module 300 to the outside. For example, the first heat dissipation member 610 may be disposed between the upper housing 510 and the LED substrates 311, 321.

The first heat dissipation member 610 may include a first heat dissipation material 610 disposed around the first LED chip 312 and a second heat dissipation material 620 disposed around the second LED chip 322. The first heat dissipation material 611 and the second heat dissipation material 612 may each be disposed to surround the first LED chip 312 and the second LED chip 322 either entirely or partially. The present disclosure is not limited thereto, and can, of course, employ other arrangement structures to maximize heat dissipation efficiency.

According to the present embodiment, since the LED module 300 may be disposed at a certain distance from the circuit board 110 through the post 400, the LED module 300 may be disposed almost parallel to the circuit board 110. In addition, since the post 400 may be attached to the back surface of the LED substrate, there is no need for a bonding application space for fixing the LED module 300, allowing heat dissipation members to be placed around the LED chip on the LED substrate.

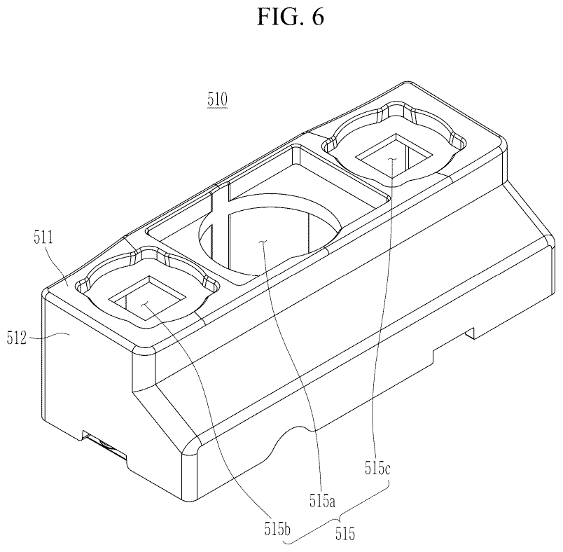

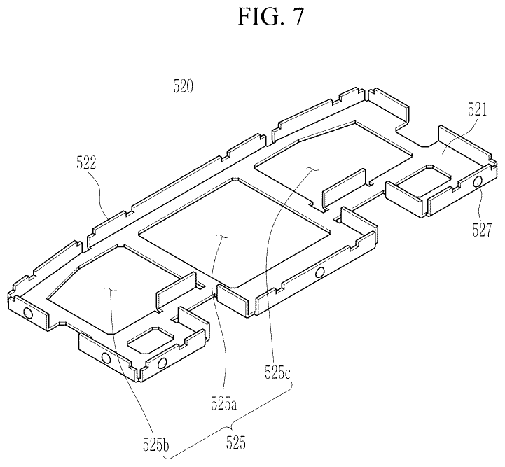

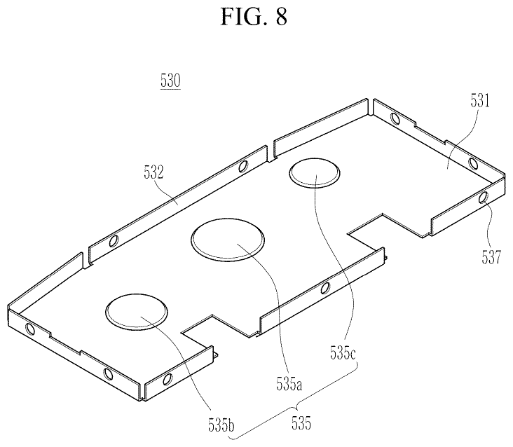

Hereinafter, the housing assembly 500 of the camera module 10 according to the present embodiment will be described in more detail with reference to FIGS. 6 to 8. FIG. 6 is a perspective view illustrating an upper housing of the camera module according to an embodiment. FIG. 7 is a perspective view illustrating a chassis of the camera module according to an embodiment. FIG. 8 is a perspective view illustrating a shield cover of the camera module according to an embodiment.

Referring to FIGS. 6 to 8, the housing assembly 500 may include an upper housing 510 and a lower housing 540, and the lower housing 540 may include a chassis 520 and a shield cover 530.

The upper housing 510 may include an upper surface portion 511 disposed above in the optical axis direction and along the direction perpendicular to the optical axis, and a side surface portion 512 extending downward along the optical axis direction from the upper surface portion 511. The upper surface portion 511 may have an approximately rectangular shape, and an opening 515 exposing a portion of the lens module 200 and the LED module 300.

The opening 515 may be formed through the upper surface portion 511 and may include a first opening 515a exposing the lens module 200, and second openings 515b, 515c exposing the LED module 300. The top of the lens module 200 may be exposed through the first opening 515a, with the lens also exposed to allow light to pass through. The top of the LED module 300 may be exposed through the second openings 515b, 515c, allowing light to be emitted from the LED chip.

The side surface portion 512 may extend downward along the optical axis direction from the edge of the upper surface portion 511. The side surface portion 512 may serve as a part to accommodate the components inside the camera module 10 and may have various shapes depending on the arrangement of the internal components, for example, it may have a prismatic shape, a cylindrical shape with an open bottom, or a hemispherical shape.

The chassis 520 may include a plate-shaped portion 521 facing one surface of the circuit board 110 and a side plate portion 522 bent along an edge of the plate-shaped portion 521 to face the side of the circuit board 110.

The opening 525 may be formed at the plate-shaped portion 521 to correspond to at least one of the electronic components installed at the circuit board 110. The opening 525 may check the installation state of the electronic component installed at the circuit board 110, and may expose the electronic component to the application of the heat dissipation member 600. The electronic component may include the image sensor 120, the serializer/deserializer 150, the power management integrated circuit 170, or the like. The image sensor 120, the serializer/deserializer 150, and the power management integrated circuit 170 may be disposed on the same surface or different surfaces of the circuit board 110. For example, the serializer/deserializer 150 and the power management integrated circuit 170 may be disposed on the back surface of an installation surface of the image sensor 120.

The opening 525 may include a first opening 525a formed corresponding to the image sensor 120, a second opening 525b formed corresponding to the serializer/deserializer 150, and a third opening 525c formed corresponding to the power management integrated circuit 170. The opening 525 may be formed corresponding to a component requiring heat dissipation among electronic components installed at the circuit board 110, and the number and sizes of openings 525 are not limited.

The first opening 525a may be formed to expose a back surface of the circuit board 110 at which the image sensor 120 is installed, the second opening 525b may be formed to expose a portion of the circuit board 110 at which the serializer/deserializer 150 is installed, and the third opening 525c may be formed to expose a portion of the circuit board 110 at which the power management integrated circuit 170 is installed.

The chassis 520 may include at least one protrusion 527 on an outer side surface thereof. The protrusion 527 may couple the chassis 520 to the shield cover 530, and may be formed on the side plate portion 522.

The shield cover 530 may accommodate the circuit board 110 and the chassis 520 and, like the chassis 520, the shield cover 530 may be manufactured by bending a plate-shaped member.

The shield cover 530 may include a bottom portion 531 in contact with the plate-shaped portion 521 of the chassis 520, and a wall portion 532 formed by bending along an edge of the bottom portion 531. The shield cover 530 may be coupled to the chassis 520 to function as a shield for an electromagnetic wave.

At least one protruding portion 535 may be formed at the bottom portion 531 to correspond to a position of an electronic component installed at the circuit board 110. That is, the protruding portion 535 may be formed corresponding to a position of the circuit board 110 at which the image sensor 120, the serializer/deserializer 150, and the power management integrated circuit 170 are installed.

The protruding portion 535 may be formed corresponding to the opening 525 of the chassis 520, and may face the electronic component installed at the circuit board 110 through the opening 525. That is, the protruding portion 535 may include a first protruding portion 535a formed corresponding to the first opening 525a, a second protruding portion 535b formed corresponding to the second opening 525b, and a third protruding portion 535c formed corresponding to the third opening 525c. The protruding portion 535 may be formed corresponding to a component requiring heat dissipation among electronic components installed at the circuit board 110, and the number and sizes of protruding portions 535 are not limited.

The first protruding portion 535a may be formed to face a portion of the circuit board 110 at which the image sensor 120 is installed, the second protruding portion 535b may be formed to face a portion of the circuit board 110 at which the serializer/deserializer 150 is installed, and the third protruding portion 535c may be formed to face a portion of the circuit board 110 at which the power management integrated circuit 170 is installed.

The shield cover 530 may include at least one hole 537 on an inner side surface thereof. The hole 537 may be coupled to the protrusion 527 of the chassis 520 to couple the chassis 520 and the shield cover 530, and may be formed at the wall portion 532. The present disclosure is not limited thereto, and the hole may be formed at the chassis, the protrusion may be formed at the chassis, and other means (e.g., another device) for coupling the chassis and the shield cover may be used.

In an assembly process of the lower housing 540, if the chassis 520 is coupled to the circuit board 110 by soldering or the like and then the protrusion 527 is fastened to the hole 537 of the shield cover 530, the chassis 520 and the shield cover 530 may be coupled to complete assembly of the lower housing 540.

A structure of the lower housing 540 may shorten an assembly time by assembling the chassis 520 to the circuit board 110 and then checking an installation state of the electronic component through the opening 525 and applying the heat dissipation member 600 and then coupling the shield cover 530 to the chassis 520 to complete the assembly of the lower housing 540. In addition, because a space for applying the heat dissipation member 600 is provided through the opening 525, an increase in a height of the camera module 10 may be minimized.

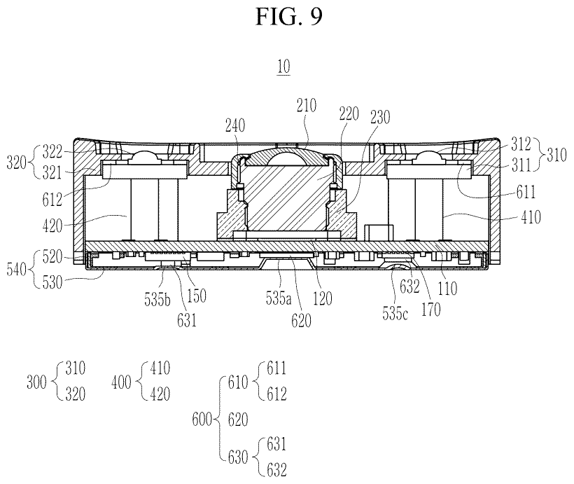

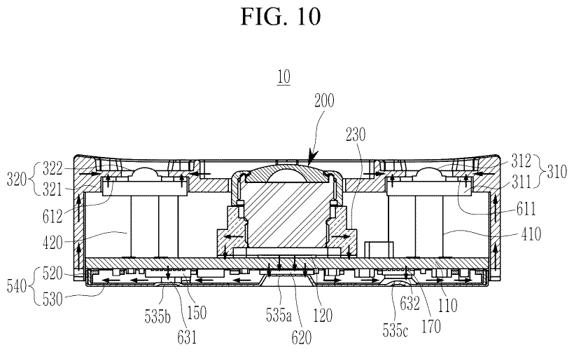

Hereinafter, a heat dissipation structure and a heat dissipation path of the camera module 10 according to the present embodiment will be described in more detail with reference to FIG. 9 and FIG. 10. FIG. 9 is a cross-sectional view taken along a line V-V′ of FIG. 1, and FIG. 10 is a view showing the heat dissipation path of the camera module according to an embodiment.

Referring to FIG. 9, the heat dissipation member 600 may be disposed between an electronic component and the housing assembly 500 to dissipate heat generated from the electronic component within the camera module 10.

The heat dissipation member 600 may act as a path for transferring heat between a heat-generating component and a heat dissipation plate disposed inside the camera module 10. A main electronic component that emits heat may include the image sensor 120, the serializer/deserializer 150, the power management integrated circuit 170, the LED module 300, or the like, and the heat dissipation plate may be the housing assembly 500. That is, the heat dissipation member 600 may transfer heat generated from the image sensor 120, the serializer/deserializer 150, the power management integrated circuit 170, the LED module 300, or the like to the housing assembly 500 to discharge the transferred heat to the outside of the camera module 10.

To this end, the heat dissipation member 600 may be in contact with the housing assembly 500. For example, a heat dissipation member disposed at the image sensor 120, the serializer/deserializer 150, and the power management integrated circuit 170 may be in contact with the lower housing 540 or the shield cover 530. In this case, the protruding portion 535 formed at the bottom portion 531 of the shield cover 530 may ensure that the heat dissipation member 600 makes firm contact between the electronic component and the shield cover 530. A heat dissipation member disposed at the LED module 300 may be in contact with the upper housing 510.

The heat dissipation member 600 may be disposed between the upper housing 510 and the LED module 300, and may be disposed between the lower housing 540 and the image sensor 120, the serializer/deserializer 150, and the power management integrated circuit 170 installed at the circuit board 110. In the lower housing 540, the heat dissipation member 600 may be disposed at the protruding portion 535 of the shield cover 530.

The heat dissipation member 600 may include a first heat dissipation member 610 disposed between the upper housing 510 and the LED module 300, a second heat dissipation member 620 disposed between the image sensor 120 and the lower housing 540, and a third heat dissipation member 630 disposed between the lower housing 540 and the serializer/deserializer 150, and the power management integrated circuit 170. The heat dissipation member 600 may be disposed to correspond to a heat-generating electronic component installed at the circuit board 110, and the number or positions of heat dissipation members 600 are not limited.

The heat dissipation member 600 may include at least one of a thermal interface material (TIM) and a phase change material (PCM). The thermal interface material (TIM) may be manufactured by mixing a polymer resin with a thermally conductive filler such as ceramic. The resin may be silicon, acrylic, or epoxy, and the thermally conductive filler may be ceramics such as aluminum oxide (Al₂O₃), boron nitride (BN), and graphite, polymers such as PP and PTFE, or metals such as silver and copper. The heat dissipation member 600 may include a heat dissipation pad, a heat dissipation film, a heat dissipation grease, a heat dissipation adhesive, a heat dissipation tape, or the like.

The first heat dissipation member 610 may include a first heat dissipation material 611 disposed around the first LED chip 312 on the first LED substrate 311, and a second heat dissipation material 612 disposed around the second LED chip 322 on the second LED substrate 321. The first heat dissipation material 611 and a second heat dissipation material 612 may each be disposed to surround the first LED chip 312 and the second LED chip 322.

The second heat dissipation member 620 may be disposed between a back surface of the circuit board 110 at which the image sensor 120 is installed and the first protruding portion 535a of the shield cover 530. The second heat dissipation member 620 may have a size corresponding to the size of the region where the image sensor 120 is installed. However, the second heat dissipation member 620 may extend to the mounting region of the lens holder 230 to additionally dissipate heat generated from the lens module 200.

The third heat dissipation member 630 may include a third heat dissipation material 631 disposed between the serializer/deserializer 150 and the second protruding portion 535b of the shield cover 530, and a fourth heat dissipation material 632 disposed between the power management integrated circuit 170 and the third protruding portion 535c of the shield cover 530.

Referring to FIG. 10, in the heat dissipation path of the camera module 10, according to the present embodiment, heat generated from the LED module 300 may be transferred to the upper housing 510 through the first heat dissipating member 610 to be emitted to the outside of the camera module 10. Specifically, heat generated from the first LED module 310 may be dissipated through the first heat dissipation material 611, and the heat generated from the second LED module 320 may be dissipated through the second heat dissipation material 612.

Heat generated from the image sensor 120 may be transferred to the shield cover 530 through the second heat dissipation member 620, and may be transferred to the upper housing 510 coupled to the shield cover 530 to be discharged to the outside of the camera module 10. At this time, heat generated from the lens module 200 may also be released outside the camera module 10 through the second heat dissipation member 620.

Additionally, heat generated from the serializer/deserializer 150 and the power management integrated circuit 170 may be transferred to the shield cover 530 through the third heat dissipation member 630, and heat transferred to the shield cover 530 may be transferred to the upper housing 510 to be discharged to the outside of the camera module 10. Specifically, heat generated from the serializer/deserializer 150 may be dissipated through the third heat dissipation material 631, and the heat generated from the power management integrated circuit 170 may be dissipated through the fourth heat dissipation material 632.

According to the present embodiment, heat generated from the electronic component disposed inside the camera module 10 may be discharged to the outside through the upper housing 510 as well as the lower housing 540, so that an efficient heat dissipation path is formed. Recently, a high-pixel image sensor has been adopted due to the high performance of a camera module, and various IC components such as a PMIC, a SerDes, an MCU, and an LED module have been embedded in the camera module. Thus, an error due to heat dissipation within the camera module in the image sensor is becoming a problem, and the present embodiment may maximize a heat dissipation effect of the camera module by forming an efficient heat dissipation path.

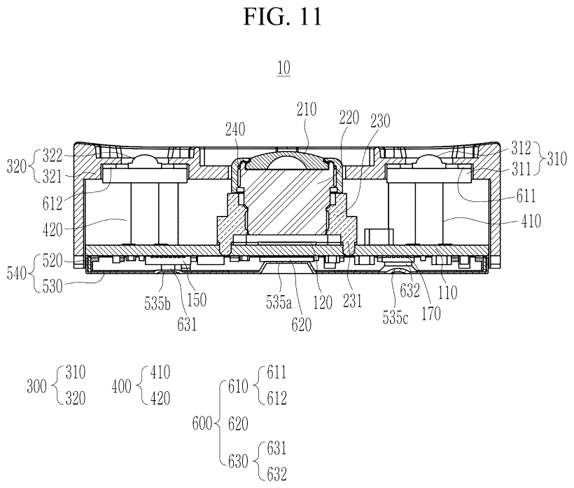

Hereinafter, a camera module 10 according to another embodiment will be described in more detail with reference to FIG. 11. FIG. 11 is a cross-sectional view schematically illustrating a camera module according to another embodiment.

The camera module illustrated in FIG. 11 may have substantially the same configuration as the embodiments described with reference to FIGS. 1 to 3. Below, different configurations are described, and the same drawing symbols are used for the same configurations, and configurations not described separately may be configured in the same manner as the embodiments illustrated in FIGS. 1 to 3.

Referring to FIG. 11, the camera module 10, according to the present embodiment, may be formed such that at least a part of the lower portion of the lens holder 230 penetrates the circuit board 110 to efficiently dissipate heat generated from the lens module 200. In other words, the lens holder 230 may include an extension part 231 that extends through the circuit board 110 from at least a part of its lower portion.

The extension part 231 may also serve to secure the lens module 200 to the circuit board 110. For this purpose, a hole where the extension part 231 is coupled may be formed in the circuit board 110.

The heat generated from the lens module 200 may be transferred to the circuit board 110 through the extension part 231 of the lens holder 230, then transferred to the shield cover 530 through the second heat dissipation member 620 disposed on the a back surface of the circuit board 110 at which the image sensor 120 is installed, and then transferred to the upper housing coupled to the shield cover 530 to be discharged to the outside of the camera module 10. At this time, the second heat dissipation member 620 may be disposed up to the lower surface of the extension part 231 to efficiently dissipate the heat transferred through the extension part 231.

One aspect of the embodiments of the present disclosure is intended to provide a camera module capable of minimizing an increase in a size thereof while forming an optimized heat dissipation path.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a lens module;
a circuit board, disposed on the lens module, on which an image sensor is disposed;
a light-emitting diode (LED) module disposed to be spaced apart from the circuit board;
a post disposed between the circuit board and the LED module to support the LED module; and
a first heat dissipation member disposed on the LED module.

2. The camera module of claim 1, wherein the LED module comprises an LED chip and an LED substrate, and the first heat dissipation member is disposed around the LED chip.

3. The camera module of claim 2, further comprising an upper housing that accommodates the lens module and the LED module, and a lower housing that couples with the upper housing and supports the circuit board.

4. The camera module of claim 3, wherein the first heat dissipation is disposed between the upper housing and the LED substrate.

5. The camera module of claim 3, wherein the upper housing comprises a surface having a first opening extending through the surface to expose the lens module, and a second opening extending through the surface to expose the LED module.

6. The camera module of claim 5, further comprising a gasket disposed in the first opening to connect the lens module with the upper housing.

7. The camera module of claim 3, wherein the lower housing comprises a chassis coupled to a lower portion of the circuit board, the chassis having a surface comprising an opening extending through the surface to expose a portion of the circuit board, and a shield cover coupled to a lower portion of the chassis.

8. The camera module of claim 1, wherein the circuit board and the LED module are electrically connected by the post.

9. The camera module of claim 1, further comprising an image sensor, disposed below the lens module, on the circuit board.

10. The camera module of claim 9, wherein further comprising a second heat dissipation member disposed on a back surface of the circuit board.

11. The camera module of claim 1, further comprising at least one third heat dissipation member disposed on a rear surface of an electronic component mounted on the circuit board.

12. The camera module of claim 11, wherein the electronic component comprises a serializer/deserializer and a power management integrated circuit.

13. The camera module of claim 1, wherein the lens module comprises a lens barrel accommodating at least one lens, and a lens holder accommodating the lens barrel.

14. The camera module of claim 13, wherein the lens holder comprises an extension part that extends through a surface of the circuit board.

15. The camera module of claim 14, further comprising a second heat dissipation member disposed below a lower surface of the extension part.

16. The camera module of claim 1, wherein the first heat dissipation member comprises either one or both of a thermal interface material and a phase change material.

17. The camera module of claim 1, wherein the first heat dissipation member comprises any one or any combination of any two or more of a heat dissipation pad, a heat dissipation film, a heat dissipation grease, a heat dissipation adhesive, and a heat dissipation tape.
